(19) United States
(12) Patent Application Publication
(10) Pub. No.: US 2003/0169530 A1
(43) Pub. Date: Sep. 11, 2003

(54) Tape drive with ESD protection

(75) Inventors: Kazuya Tamura, Tokyo (JP); Eiichi Yoneyama, Tokyo (JP); Yoshinori Tangi, Tokyo (JP); Philip Turner, Boulder, CO (US)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Mitsumi Electric Co., Ltd., Tokyo (JP)

(21) Appl. No.: 10/091,884

(22) Filed: Mar. 6, 2002

(51) Int. Cl. G11B 15/00

(52) U.S. Cl. 360/93

(57) ABSTRACT

In a tape drive (10) comprising a conductive chassis (20) having a front bezel (21) formed on its front side and circuit components mounted on the front bezel, such as a switch (22) for an eject button (251) and light-emitting diodes (23), the front bezel (21) is provided with a projection (211) formed thereon to project forward in the vicinity of the switch (22). Thus, the projection (211) has a function as a lightning rod. The front bezel (21) is covered with a front panel (25). The chassis (20) has a lower surface (20L) covered with a circuit board (90). The circuit board and the above-mentioned circuit components are electrically connected with each other through a flexible printed circuit (27).

### BACKGROUND OF THE INVENTION

This invention relates to a tape drive such as a linear tape storage system represented by DLT (Digital Linear Tape) or LTO (Linear Tape Open) and, in particular, to electrostatic discharge (ESD) protection for a tape drive.

A tape drive of the type has been developed as a “backup” system for use in a hard disk of a computer system. A variety of linear storage systems have heretofore been proposed. For example, a digital linear tape drive serving as the DLT is disclosed in U.S. Pat. No. 5,862,014 to Nute, entitled “Multi-channel Magnetic Tape Head Module Including Flex Circuit”.

The digital linear tape drive (hereinafter may simply be called “driving apparatus”, “tape drive” or “drive”) is adapted to receive a tape cartridge (hereinafter may simply be called “cartridge”) having a single reel (supply reel). The digital linear tape drive includes a take-up reel in the interior thereof. When the tape cartridge is received in the driving apparatus, a magnetic tape is pulled out from the tape cartridge to be taken up around the take-up reel through a head guide assembly (HGA). The head guide assembly serves to guide, to a magnetic head, the magnetic tape (hereinafter may simply be called “tape”) pulled out from the tape cartridge. The magnetic head exchanges information between the tape and the magnetic head. Typically, the head guide assembly comprises an aluminum plate having a boomerang-like shape and six large guide rollers, each comprising a bearing.

The head guide assembly is also called a tape guide assembly which is disclosed, for example, in U.S. Pat. No. 5,414,585 to Saliba, entitled “Rotating Tape Edge Guide”. An example of the guide roller is disclosed in Japanese Unexamined Patent Publication No. 2000-100025.

As disclosed in U.S. Pat. No. 5,793,574 to Cranson et al., entitled “Tape Head Actuator Assembly Having A Shock Suppression Sleeve” for example, a tape drive typically comprises a substantially rectangular housing having a common base. The base has two spindle motors (reel motors). The first spindle motor has a spool (take-up reel) permanently mounted to the base. The spool is dimensioned to accept a magnetic tape streaming at a relatively high speed. The second spindle motor (reel motor) is adapted to receive a removable tape cartridge. The removable tape cartridge is manually or automatically inserted into the drive via a slot formed on the housing of the drive. When the tape cartridge is inserted into the slot, the cartridge is engaged with the second spindle motor (reel motor). Prior to rotation of the first and the second spindle motors (reel motors), the tape cartridge is connected to the permanently mounted spool (take-up reel) by means of a mechanical buckling mechanism. A number of rollers (guide rollers) positioned between the tape cartridge and the permanent spool guide the magnetic tape as it streams at a relatively high speed back and forth between the tape cartridge and the permanently mounted spool.

The digital linear tape drive of the above-mentioned structure requires a device for pulling the tape from the supply tape reel to the take-up reel. Such pulling device is disclosed, for example, in International Publication No. WO86/07471. According to WO86/07471, the take-up reel is provided with take-up leader means (first tape leader) coupled thereto. To the tape on the supply reel, supply tape leader means (second tape leader) is fixed. The first tape leader has a mushroom-shaped tab formed at its one end. The second tape leader has a locking hole. The tab is engaged with the locking hole.

Furthermore, a mechanism for joining the first tape leader to the second tape leader is required. Such joining mechanism is disclosed, for example, in International Publication No. WO86/07295.

Japanese Unexamined Patent Publication No. 2000-100116 discloses a structure of a leader tape engaging part capable of locking an end of a leader tape (second tape leader) to a tape end hooking part of the tape cartridge without requiring a tab protruding on a lateral side of the leader tape.

U.S. Pat. No. 5,857,634 to Hertrich, entitled “Take-up Reel Lock” discloses a lock system for preventing the rotation of the take-up reel of the tape drive when the tape cartridge is not inserted into the drive.

The tape drive further comprises a tape head actuator assembly. The tape head actuator assembly is positioned between the take-up spool and the tape cartridge along a tape path defined by a plurality of rollers. In operation, the magnetic tape streams back and forth between the take-up spool and the tape cartridge, coming into close proximity to the head actuator assembly while streaming along the defined tape path. An example of the head actuator assembly of the type is disclosed in U.S. Pat. No. 5,793,574 mentioned above.

On the other hand, Japanese Unexamined Patent Publication No. 2000-149491 discloses an example of the tape cartridge to be received in the digital linear tape drive.

Moreover, U.S. Pat. No. 6,241,171 to Gaboury, entitled “Leaderless Tape Drive” discloses a tape drive in which a tape leader is pushed and moved from a tape cartridge to a take-up reel without using a buckling mechanism or a take-up leader.

As described above, the tape drive comprises the first and the second reel motors which are mounted on a conductive chassis. Each of the first and the second reel motors typically comprises an inner-rotor motor.

Specifically, the first reel motor comprises a motor board made of a magnetic material, a rotor rotatably attached onto the motor board, and a stator fixedly mounted on the motor board. The first reel motor is an inner-rotor motor in which the rotor is disposed inside the stator. The first reel motor has a cylindrical rotation supporting member fixed to the motor board and vertically standing up from an approximate center thereof. The rotor is rotatably supported on the cylindrical rotation supporting member through a ball bearing. Specifically, the rotor comprises a rotary shaft, a dish-like rotary member, and a ring-shaped magnet. The rotary shaft is attached to the cylindrical rotation supporting member through the ball bearing. The dish-like rotary member extends from a lower end of the rotary shaft in a direction perpendicular to an extending direction of the rotary shaft and has an outer peripheral end portion perpendicularly bent upward. The ring-shaped magnet is fixedly attached to an outer peripheral surface of the outer peripheral end portion of the dish-like rotary member.

On the other hand, the stator is disposed on the motor board in close proximity to an outer peripheral side of the ring-shaped magnet. The stator comprises a plurality of stator cores radially extending and stator coils wound around the stator cores, respectively.

To the back surface of the conductive chassis in an area where the first reel motor is mounted, attached is a circuit board for mounting a large number of circuit components such as an integrated circuit (IC) for driving the above-mentioned tape drive.

On the other hand, the conductive chassis has a front bezel formed on its front side. Circuit components are mounted on the front bezel. The circuit components include, for example, a switch for an eject button and a light-emitting diode (LED). The front bezel is covered with a front panel provided with the eject button. The above-mentioned circuit board and the circuit components are electrically connected with each other through a flexible printed circuit (FPC). Here, the chassis is grounded.

As one of performance tests for the tape drive, an electrostatic discharge (ESD) test is known. In the ESD test, performance of the tape drive is tested by applying static electricity having a predetermined voltage to the tape drive. In this event, it is common that an impulse voltage is applied to the front side of the tape drive via the vicinity of the eject button. This is because, in a normal working state, static electricity charged in a human body is discharged between a human finger and the eject button when the eject button is going to be operated, as well known.

However, if a high impulse voltage as the above-mentioned static electricity is applied to the tape drive, the circuit components such as the switch and the LED may possibly be damaged. Further, the high impulse voltage may be transmitted to the circuit board through the FPC, resulting in a damage to the expensive IC mounted thereon.

However, in the existing tape drive, any ESD protection in terms of the ESD test is not provided. It is therefore difficult to prevent the circuit components or the IC from being damaged, as described in the foregoing. Accordingly, some ESD protection is desired.

### SUMMARY OF THE INVENTION

It is therefore an object of the present invention to provide a tape drive with ESD protection.

Other objects of the present invention will become clear as the description proceeds.

Stating the gist of the first aspect of the present invention, it will be understood that a tape drive serves to perform information exchange between it and a magnetic tape. The tape drive comprises a conductive chassis having a front bezel on its front side, and circuit components mounted on the front bezel. According to the first aspect of the present invention, the front bezel is provided with a projection formed thereon to project forward.

In the above-mentioned first aspect of the present invention, the abovementioned circuit components may include, for example, a switch for an eject button. In this case, it is preferable that the above-mentioned projection is formed on the front bezel in the vicinity of the switch. Further, the front bezel may be covered with a front panel. In addition, the chassis has an upper surface and a lower surface. The lower surface may be covered with a circuit board. In this case, it is preferable that the circuit board and the above-mentioned circuit components are electrically connected with each other through a flexible printed circuit.

Stating the gist of a second aspect of the present invention, it will be understood that a drive comprises a conductive chassis having a front bezel on its front side, and circuit components mounted on the front bezel. According to the second aspect of the present invention, the front bezel is provided with a projection formed thereon to project forward.

In the above-mentioned second aspect of the present invention, the above-mentioned circuit components may include, for example, a switch for an eject button. In this case, it is preferable that the above-mentioned projection is formed on the front bezel in the vicinity of the switch. Further, the front bezel may be covered with a front panel.

### BRIEF DESCRIPTION OF THE DRAWINGS

FIG. 1 is a perspective view of a tape drive according to one embodiment of the present invention in a state where an upper cover is removed;

FIG. 2 is a perspective view of the tape drive illustrated in FIG. 1 as seen from a back surface side;

FIG. 3 is a sectional view of the tape drive illustrated in FIG. 1;

FIG. 4 is a partially-enlarged perspective view showing a front part of the tape drive illustrated in FIG. 2 in an enlarged scale; and

FIG. 5 is a perspective view showing a connection of circuit components mounted on a front bezel of a chassis in the tape drive illustrated in FIG. 2 and a circuit board covering the back surface of the chassis.

### DESCRIPTION OF THE PREFERRED EMBODIMENT

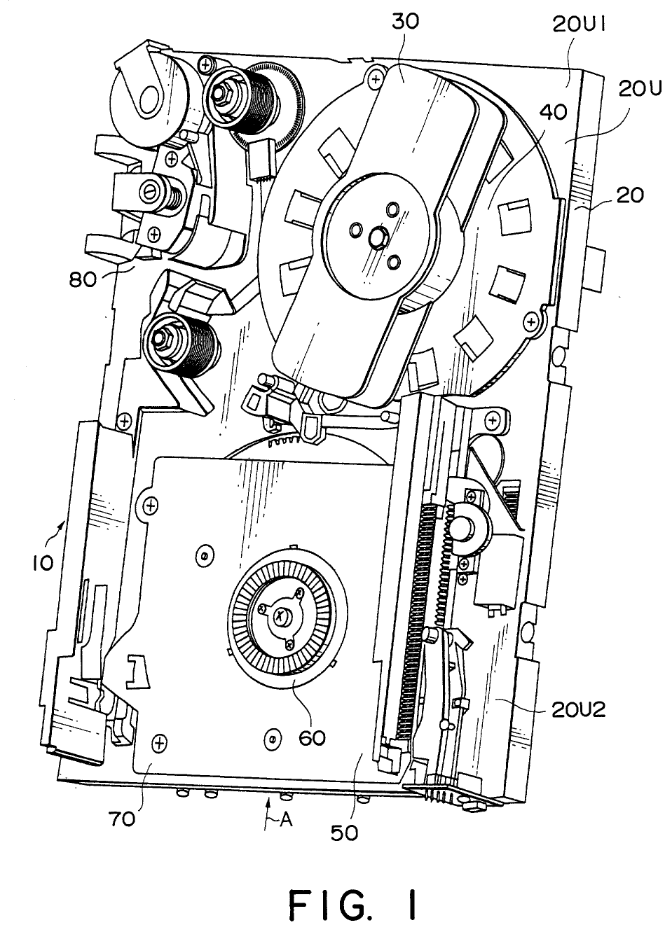

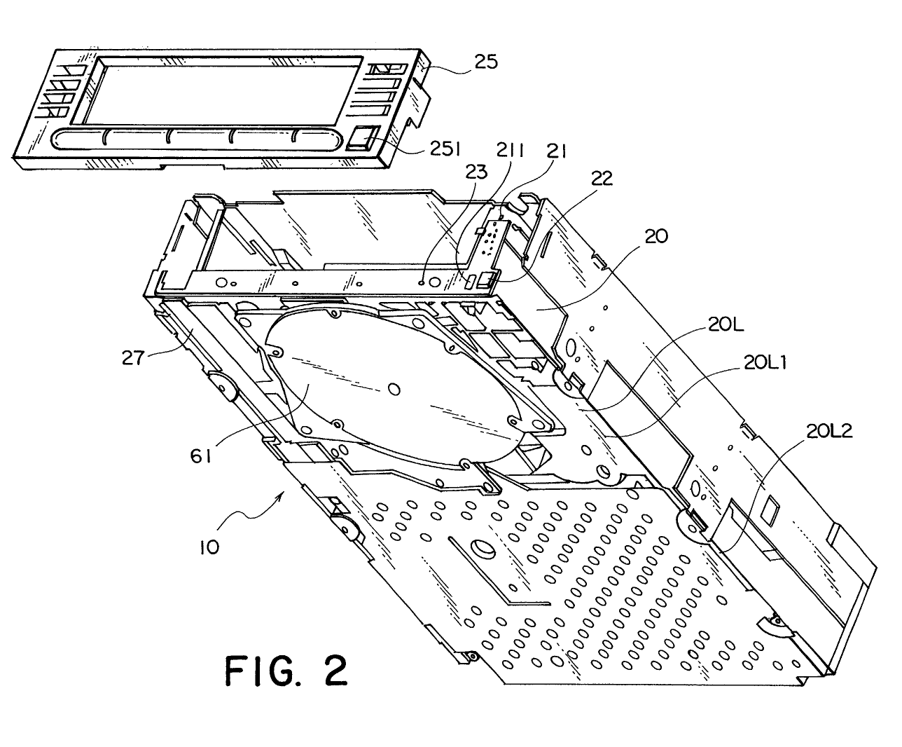

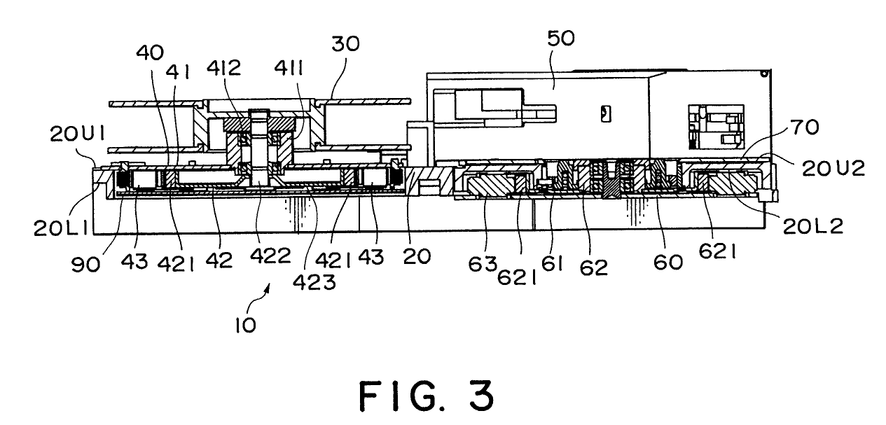

Referring to FIGS. 1, 2 and 3, description will be made about a tape drive according to one embodiment of the present invention. FIG. 1 is a perspective view of the tape drive 10, showing a state where an upper cover is removed. FIG. 2 is a perspective view of the tape drive 10 in FIG. 1 as seen from a back surface side. FIG. 3 is a sectional view of the tape drive 10 in FIG. 1.

The tape drive 10 comprises a conductive chassis 20 having an upper surface 20U and a lower surface 20L. The upper surface 20U is divided into a first upper region 20U1 and a second upper region 20U2. Similarly, the lower surface 20L is divided into a first lower region 20L1 and a second lower region 20L2 facing the first upper region 20U1 and the second upper region 20U2, respectively.

The tape drive 10 further comprises a take-up reel 30, a first reel motor 40, a slot portion 50, and a second reel motor 60. The first reel motor 40 may be called a take-up reel motor, and the second reel motor 60 may be called a supply reel motor.

The take-up reel 30 is rotatably attached onto the first upper region 20U1 of the chassis 20. The first reel motor (take-up reel motor) 40 is attached to the first lower region 20L1 of the chassis 20 and serves as a motor for driving and rotating the take-up reel 30. As shown in FIG. 3, the first reel motor 40 comprises a first motor board 41 made of a magnetic material, a first rotor 42 rotatably attached onto the first motor board 41, and a first stator 43 fixedly mounted to the first motor board 41. The first reel motor 40 is an inner-rotor motor in which the first rotor 42 is disposed inside the first stator 43. The first rotor 42 comprises a first ring-shaped magnet 421.

On the other hand, the slot portion 50 is formed on the second upper region 20U2 of the chassis 20. To the slot portion 50, a tape cartridge (not shown) is inserted along an insertion direction depicted by an arrow A in FIG. 1. The tape cartridge comprises a rotatable supply reel and a magnetic tape wound around the supply reel. The second reel motor (supply reel motor) 60 is attached to the second lower region 20L2 of the chassis 20 and serves as a motor for driving and rotating the supply reel when the tape cartridge is inserted into the slot portion 50. The second reel motor 60 comprises a second motor board 61 made of a magnetic material, a second rotor 62 rotatably attached onto the second motor board 61, and a second stator 63 fixedly mounted on the second motor board 61. Like the first reel motor 40, the second reel motor 60 is an inner-rotor motor in which the second rotor 62 is disposed inside the second stator 63. The second rotor 62 has a second ring-shaped magnet 621.

As apparent from FIG. 3, the first reel motor (take-up reel motor) 40 is arranged in a reversed position with respect to the second reel motor (supply reel motor) 60. In other words, in the first reel motor 40, the first rotor 42 and the first stator 43 are arranged on the lower surface of the first motor board 41. In the second reel motor 60, the second rotor 62 and the second stator 63 are arranged on the upper surface of the second motor board 61. Thus, in the second reel motor 60, the second ring-shaped magnet 621 of the second rotor 62 is exposed on the outside. Since the second ring-shaped magnet 621 has strong magnetism, the second reel motor 60 is covered with a plate 70 made of an iron-based magnetic material in order to shield magnetic leakage.

In the tape drive 10 of the above-mentioned structure, it is possible to carry out information exchange between a magnetic head 80 and a magnetic tape (not shown) pulled out from the supply reel and wound around the take-up reel 30.

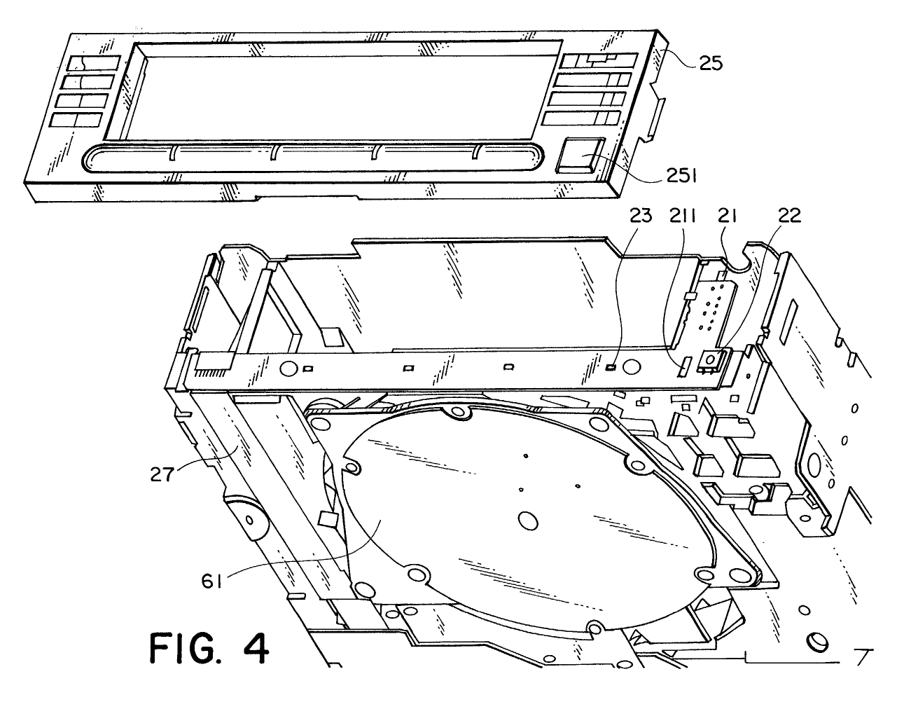

Referring to FIG. 4 in addition to FIG. 2, the conductive chassis 20 has a front bezel 21 formed on its front side. On the front bezel 21, circuit components, such as a switch 22 for an eject button (which will be described later) and light-emitting diodes (LED) 22 [should be corrected into 23?], are mounted. The front bezel 21 is covered with a front panel 25 provided with the above-mentioned eject button 251.

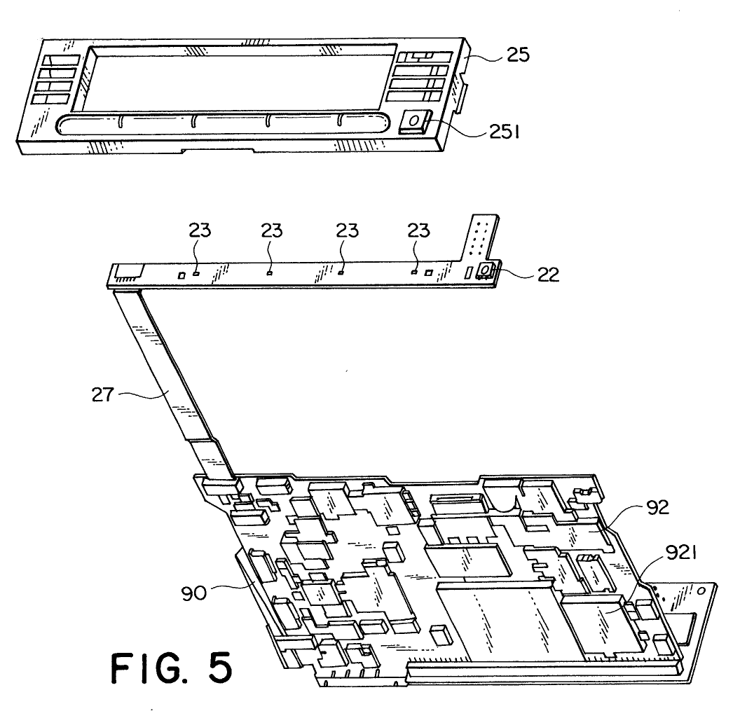

Referring to FIG. 5 in addition to FIG. 3, to the back surface 20L1 of the chassis 20 in an area where the first reel motor 40 is mounted, attached is a circuit board 90 with a large number of circuit components 92, such as an integrated circuit (IC) 921 for driving the above-mentioned tape drive 10, mounted thereon. The circuit board 90 and the circuit components 22 and 23 mounted on the above-mentioned front bezel 21 are electrically connected with each other through a flexible printed circuit (FPC) 27. Here, the chassis 20 is grounded.

As described above, an electrostatic discharge (ESD) test is known as one of performance tests for the tape drive 10. In the ESD test, performance of the tape drive 10 is tested by applying static electricity having a predetermined voltage to the tape drive 10. In this event, it is common that an impulse voltage is applied to the front side of the tape drive 10 via the vicinity of the eject button 251. This is because, in a normal working state, static electricity charged in a human body is discharged between a human finger and the eject button 251 when the eject button 251 is going to be operated, as well known.

However, if a high impulse voltage as the above-mentioned static electricity is applied to the tape drive 10, the circuit components such as the switch 22 and the LEDs 23 may possibly be damaged. Further, the high impulse voltage may be transmitted to the circuit board 90 through the FPC 27, resulting in a damage to the expensive IC 921 mounted thereon.

As described above, in the existing tape drive, any ESD protection in terms of the ESD test is not provided. It is therefore difficult to prevent the circuit components 22 and 23 or the IC 921 from being damaged. Accordingly, some ESD protection desired.

Taking the above into consideration, in the present invention, the front bezel 21 is provided with a projection 211 formed thereon to project forward in the vicinity of the switch 22, as shown in FIGS. 2 and 4. Thus, the projection 211 has a function as a so-called lightning rod.

For instance, it is supposed that a person charged with static electricity attempts to operate the eject button 251 and brings his or her finger close to the eject button 251. In this event, discharge resulting from the static electricity charged in the human body occurs between his or her finger and the projection 211. Consequently, electricity produced by the discharge flows to the chassis 20 which is grounded. Therefore, it is possible to prevent the switch 22 and the LEDs 23 from being damaged. Further, inasmuch as all of the electric current produced by the discharge flows to the chassis 20, it is possible to prevent a high impulse voltage from being applied to the circuit board 90 through the FPC 27. As a result, it is also possible to prevent the expensive IC 921 mounted on the circuit board 90 from being damaged.

As thus far been described in conjunction with the preferred embodiment of the present invention, it will readily be understood that a variety of modifications can be made by those skilled in the art within a scope which does not deviate from the spirit of the present invention. For example, in the foregoing embodiment, description has been made about the case where the drive is a tape drive by way of example. However, it is readily understood that the present invention is similarly applicable to other drives, such as a flexible disk drive, except the tape drive. Moreover, in the foregoing embodiment, the projection 211 is formed in the vicinity of the switch 22 of the eject button 251. However, the position at which the projection is formed is not limited to that mentioned above but may be anywhere on the front bezel 21. Further, it is readily understood that the number of the projection 211 is not limited to one.

What is claimed is:

1. A tape drive (10) for performing information exchange between a magnetic tape and said tape drive, said tape drive comprising:
a conductive chassis (20) having a front bezel (21) formed on its front side;
circuit components (22, 23) mounted on said front bezel; and
a projection (211) formed on said front bezel to project forward.

2. A tape drive as claimed in claim 1, wherein said circuit components include a switch (22) for an eject button (251), said projection being formed on said front bezel in the vicinity of said switch.

3. A tape drive as claimed in claim 1, wherein said front bezel (21) is covered with a front panel (25).

4. A tape drive as claimed in claim 1, wherein said chassis (20) has an upper surface (20U) and a lower surface (20L), said lower surface being covered with a circuit board (90), said circuit board and said circuit components being electrically connected with each other through a flexible printed circuit (27).

5. A drive (10) comprising:
a conductive chassis (20) having a front bezel (21) formed on its front side;
circuit components (22, 23) mounted on said front bezel; and
a projection (211) formed on said front bezel to project forward.

6. A drive as claimed in claim 5, wherein said circuit components include a switch (22) for an eject button (251), said projection being formed on said front bezel in the vicinity of said switch.

7. A drive as claimed in claim 5, wherein said front bezel (21) is covered with a front panel (25).
